(19) United States
(12) Patent Application Publication
(10) Pub. No.: US 2017/0236625 A1
(43) Pub. Date: Aug. 17, 2017

(54) RESISTANCE ADJUSTMENT CIRCUIT, LOAD DETECTOR, AND RESISTANCE ADJUSTMENT METHOD

(71) Applicant: ALPS ELECTRIC CO., LTD., Tokyo (JP)

(72) Inventor: Mitsuru Saito, Miyagi-ken (JP)

(21) Appl. No.: 15/420,700

(22) Filed: Jan. 31, 2017

(30) Foreign Application Priority Data
Feb. 16, 2016 (JP) 2016-026586

(51) Int. Cl. H01C 17/242; G01L 1/22; G01L 1/20; H01C 13/02

(52) U.S. Cl. CPC H01C 17/242; H01C 13/02; G01L 1/2268; G01L 1/205

(57) ABSTRACT

A resistance adjustment circuit has a plurality of conductive patterns placed in parallel to one another on a flat surface formed from an insulating body so as to extend in a first direction, and also has a resistive element that spans two conductive patterns and is electrically connected to the conductive patterns at superimposing parts superimposed on the conductive patterns. A plurality of resistive elements are provided so as to be spaced in the first direction and are connected in parallel to one another across the two conductive patterns. Part of the conductive patterns can be selectively cut between the superimposing parts of resistive elements disposed adjacently. The combined resistance of the resistance adjustment circuit can be adjusted by reducing parallel connections of resistive elements or combining parallel connections of resistive elements with their series connections.

### CLAIM OF PRIORITY

This application claims benefit of priority to Japanese Patent Application No. 2016-026586 filed on Feb. 16, 2016 hereby incorporated by reference in its entirety.

### BACKGROUND

1. Field of the Disclosure

The present disclosure relates to a resistance adjustment circuit for which trimming is possible, a load detector that has the resistance adjustment circuit, and a resistance adjustment method.

2. Description of the Related Art

Recently, in order to improve the performance of seat belts, air bags, and other types of safety apparatuses, the operation of these safety apparatuses may be controlled according to the weight of a passenger sitting on a vehicle-mounted seat. When, for example, a small child is sitting on the front passenger seat or an infant wearing an auxiliary tool is sitting on a seat, if an air bag operates, a risk may be involved. In view of this, a load detector has been developed that uses a method of measuring a weight on a seat to detect an approximate body build of a passenger (see Japanese Unexamined Patent Application Publication No. 2005-241610, for example).

FIG. 9 illustrates a state in which passenger load detectors 900 disclosed in Japanese Unexamined Patent Application Publication No. 2005-241610 are attached to a vehicle and a seat. FIG. 10 illustrates the shapes of strain gages R911 and R912 that have ladder-shaped resistors R921 and R922 used for resistance adjustment. Japanese Unexamined Patent Application Publication No. 2005-241610 describes that if a difference occurs between the inter-grid resistances of two axes, a predetermined ladder portion is cut according to the value of the difference to make a match between the resistances of the two axes.

As illustrated in FIG. 9, a total of four passenger load detectors 900 described in Japanese Unexamined Patent Application Publication No. 2005-241610 are attached to the lower surfaces of the two rails of a seat; two passenger load detectors 900 are attached to each rail, one at the front and one at the back.

With the passenger load detector 900 in Japanese Unexamined Patent Application Publication No. 2005-241610, a metal sintered body is used as a distortion generating body and a stainless steel plate for use for a spring is used as a reinforcing plate. The metal sintered body is manufactured by press molding raw material powder and then sintering it. A strain gage 910 is formed by bonding a metal resistive foil obtained from a rolled alloy and a polyimide film together with a thermosetting adhesive. The strain gage 910 has two gages R911 and R912 having different sensitive axial directions. As illustrated in FIG. 10, the strain gage 910 further has the ladder-shaped resistors R921 and R922 attached to these gages. In addition, a pattern of gage tabs T911, T912, and T913 used for wire connections is formed by a photolithography process.

When a ladder-shaped resistor is formed from the same resistive element as in a strain gage and the resistance of the ladder-shaped resistor is adjusted by cutting part of it, this is advantageous in that the ladder-shaped resistor and strain gage have the same temperature coefficient. In practical use, however, a crack is generated in the resistive element from a portion at which the resistive element was cut, which changes its resistance. Therefore, it has been demanded to achieve a resistance adjustment circuit having a stable adjusted resistance without having to complicating a manufacturing process.

### SUMMARY

Disclosed is a resistance adjustment circuit and load detector in which an adjusted resistance is not changed, as well as a resistance adjustment method.

The resistance adjustment circuit has a plurality of conductive patterns placed in parallel to one another on a flat surface formed from an insulating body so as to extend in a first direction, and also has a resistive element that spans two conductive patterns and is electrically connected to the conductive patterns at superimposing parts superimposed on the conductive patterns. A plurality of resistive elements are provided so as to be spaced in the first direction and are connected in parallel to one another across the two conductive patterns. Part of the conductive patterns can be selectively cut between the superimposing parts of resistive elements disposed adjacently.

In this structure, when part of the conductive patterns is selectively cut to reduce the number of parallel connections of resistive elements or combine parallel connections of resistive elements with their series connections, the combined resistance of the resistance adjustment circuit can be adjusted. Since part of the conductive patterns is cut instead of cutting part of the resistive elements, the resistances of the resistive elements themselves do not change with time. Therefore, the combined resistance of the resistance adjustment circuit after the adjustment is stably maintained at a desired value.

### BRIEF DESCRIPTION OF THE DRAWINGS

FIG. 1 is a schematic plan view illustrating a resistance adjustment circuit in a first embodiment of the present invention;

FIG. 2 is an equivalent circuit diagram illustrating the resistance adjustment circuit in the first embodiment;

FIGS. 3A to 3D are equivalent circuit diagrams illustrating four examples of a resistance combined in a resistance adjustment method in the first embodiment;

FIG. 4 is a perspective view illustrating a load detector in a second embodiment of the present invention;

FIG. 5 is a bottom view illustrating the load detector in the second embodiment;

FIG. 6 is a circuit diagram illustrating a detecting part;

FIG. 7 is an equivalent circuit diagram illustrating an example of electric connections between the detecting part and the resistance adjustment circuit;

FIG. 8 is a flowchart illustrating a resistance adjustment method in the second embodiment;

FIG. 9 illustrates a state in which conventional passenger load detectors are attached to a vehicle and a seat; and

FIG. 10 illustrates the shape of a strain gage having ladder-shaped resistors used for resistance adjustment in the conventional passenger load detector.

### DESCRIPTION OF THE EXEMPLARY EMBODIMENTS

Embodiments of the present invention will be described in detail with reference to the drawings. For easy understanding, dimensions in the drawings are appropriately changed.

### First Embodiment

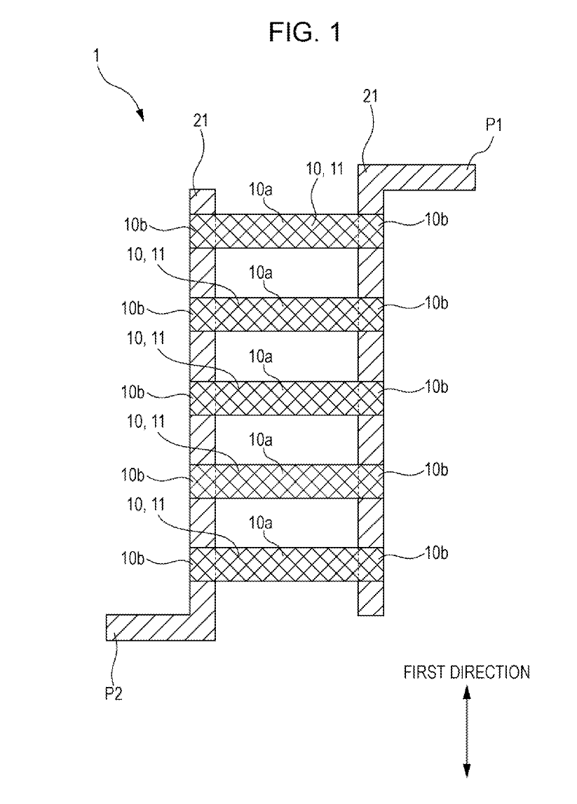

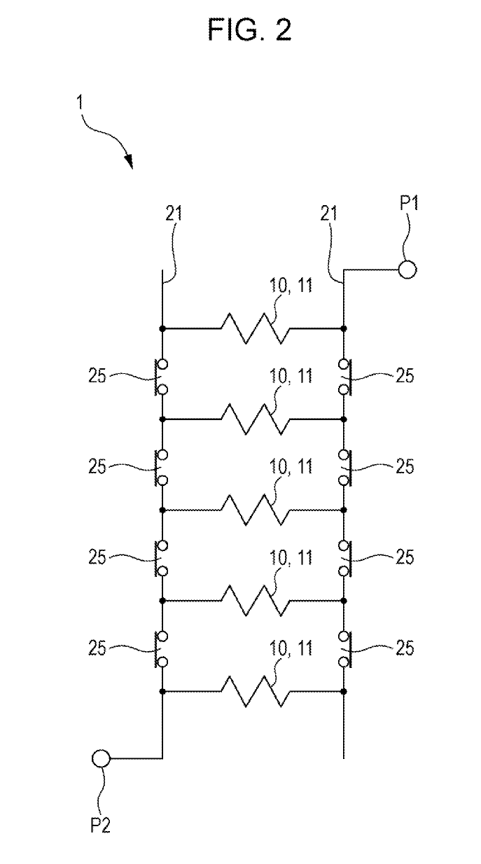

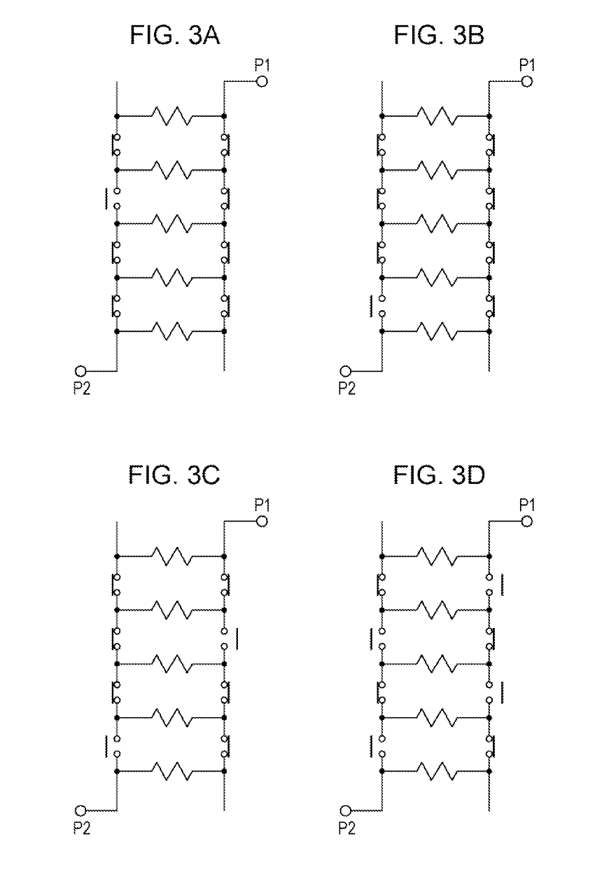

FIG. 1 is a schematic plan view illustrating a resistance adjustment circuit 1 in the first embodiment. FIG. 2 is an equivalent circuit diagram illustrating the resistance adjustment circuit 1 in the first embodiment. FIGS. 3A to 3D are equivalent circuit diagrams illustrating four examples of a resistance combined in a resistance adjustment method in the first embodiment.

Resistance Adjustment Circuit

As illustrated in FIG. 1, the resistance adjustment circuit 1 in this embodiment has a plurality of conductive patterns 21 and a plurality of resistive elements 10, and is placed on a flat surface formed from an insulating body. Although FIG. 1 is a schematic plan view, the conductive patterns 21 and resistive elements 10 are hatched for viewing comfort. The plurality of conductive patterns 21 (two conductive patterns 21 in FIG. 1) are placed in parallel to one another so as to extend in a first direction. The plurality of resistive elements 10 (5 resistive elements 10 in FIG. 1) are placed so as to be spaced in the first direction.

Each conductive pattern 21, which is preferably formed from a conductive film including silver, is formed by performing screen printing on a flat surface formed from an insulating body. The conductive pattern 21 has a much lower resistance than the resistive element 10 and thereby functions as a circuit wire in the resistance adjustment circuit 1.

Each resistive element 10 is preferably a resistive pattern 11 formed from a resistive film including a resistive material. An example of the material element is a ruthenium oxide (RuO₂) material. By screen-printing a raw material in paste form or printing it in another method and then sintering the raw material, the resistive pattern 11 can be formed as a resistive film in which the resistive material is mixed with an inorganic binder.

In the resistance adjustment circuit 1 in this embodiment, five resistive patterns 11 each span the two conductive patterns 21, which extend in the first direction with a predetermined space between them, and are superimposed on the conductive patterns 21 at superimposing parts 10b, as illustrated in FIG. 1. Each resistive pattern 11 is electrically connected to the conductive patterns 21 at the relevant superimposing parts 10b. A resistive part 10a is used to determine the resistance of the resistive element 10. In this embodiment, all resistive parts 10a are formed from the same material so as to have the same length, width, and thickness, so they have the same resistance within a range of variations in manufacturing. Therefore, the five resistive patterns 11 function as the resistive elements 10 having the same resistance.

In the resistance adjustment circuit 1, five resistive elements 10 are connected in parallel to one another between a predetermined position P1 on one conductive pattern 21 and a predetermined position P2 on the other conductive pattern 21 with two conductive patterns 21 intervening between them. A combined resistance generated across the predetermined position P1 on the one conductive pattern 21 and the predetermined position P2 on the other conductive pattern 21 can be adjusted.

Resistance Adjustment Method

In the resistance adjustment method, a trimming process to cut part of the circuit structure is performed at an intermediate point in manufacturing. In the trimming process, part of the conductive patterns 21 in the resistance adjustment circuit 1 is cut to adjust the combined resistance generated across the predetermined position P1 and the predetermined position P2.

The trimming process, in which part of the conductive patterns 21 is cut, is preferably performed by using a laser. Since the conductive pattern 21 in the resistance adjustment circuit 1 is formed by, for example, performing screen printing on a flat surface, the conductive pattern 21 can be easily removed by cutting it by using a laser. Since part of the conductive pattern 21 is cut between the superimposing part 10b of one resistive element 10 and the superimposing part 10b of an adjacent resistive element 10, there is no risk of a crack or the like being generated in these resistive elements 10. After the trimming process, therefore, the resistances of the resistive elements 10 themselves do not change with time. This enables the combined resistance of the resistance adjustment circuit 1 after the trimming process to be stably maintained at a desired value.

Next, an example of the resistance combined in the resistance adjustment method in this embodiment will be described. When a conductive pattern 21 electrically connected to the superimposing part 10b of a resistive element 10 is cut by a laser, the cut portion is shut down in the circuit. In FIG. 2, the resistance adjustment circuit 1 is schematically illustrated as an equivalent circuit that has switches 25, which are turned off, at cut portions. When the eight switches 25 in FIG. 2 are selectively turned off, the number of parallel connections of resistive elements 10 can be reduced or parallel connections of resistive elements 10 can be combined with their series connections. This enables the combined resistance to be adjusted.

For easy understanding, it will be assumed that all resistive elements 10 have a resistance of 15 kilohms (kΩ). Since all resistive elements 10 have the same resistance, their combined resistance can be easily calculated. The combined resistance across the predetermined position P1 and the predetermined position P2 is 3 kΩ when trimming is not performed.

As illustrated in FIGS. 3A to 3D, the combined resistance after the trimming process varies depending on the position at which the switch that is cut by using a laser. In FIG. 3A, two resistive elements 10 are separated from the circuit, resulting in a parallel connection of three resistive elements 10. Therefore, the combined resistance becomes 5 kΩ. In FIG. 3B, four resistive elements 10 are separated from the circuit, resulting in a parallel connection of only one resistive element 10. Therefore, the combined resistance becomes 15 kΩ. In FIG. 3C, a plurality of parallel circuits are combined and these parallel circuits are combined with a series connection. Therefore, the combined resistance becomes 30 kΩ. In FIG. 3D, a series circuit of five resistive elements 10 is formed, so the combined resistance becomes 75 kΩ. Besides the examples in FIGS. 3A to 3D, the switches can be appropriately selected so that a combined resistance close to the desired resistance can be obtained.

Effects in this embodiment will be described below.

The resistance adjustment circuit 1 in this embodiment has a plurality of conductive patterns 21 placed in parallel to one another on a flat surface formed from an insulating body so as to extend in a first direction, and also has a resistive element 10 that spans two conductive patterns 21 and is electrically connected to the conductive patterns 21 at superimposing parts 10b superimposed on the conductive patterns 21. A plurality of resistive elements 10 are provided so as to be spaced in the first direction and are connected in parallel to one another across the two conductive patterns 21. Part of the conductive patterns 21 can be selectively cut between the superimposing parts 10b of resistive elements 10 disposed adjacently.

In this structure, when part of the conductive patterns 21 is selectively cut to reduce the number of parallel connections of resistive elements 10 or combine parallel connections of resistive elements 10 with their series connections, the combined resistance of the resistance adjustment circuit 1 can be adjusted. Since part of the conductive patterns 21 is cut instead of cutting part of the resistive elements 10, the resistances of the resistive elements 10 themselves do not change with time. Therefore, the combined resistance of the resistance adjustment circuit 1 after the adjustment is stably maintained at a desired value.

Each conductive pattern 21 is preferably formed from a conductive film including silver, and each resistive element 10 is preferably a resistive pattern 11 formed from a resistive film including a resistive material. In this structure, both the conductive pattern 21 formed from a conductive film including silver and the resistive pattern 11 formed from a resistive film including a resistive material can be formed by, for example, screen printing, so their formation is easier than when they are formed by, for example, bonding metal foil plates together.

All resistive elements 10 are preferably placed so as to have the same resistance. In this structure, when the number of parallel connections of resistive elements 10 is reduced or parallel connections of resistive elements 10 are combined with their series connections, a resistance can be easily calculated.

The resistance adjustment method in this embodiment is applied to a resistance adjustment circuit 1 that has two conductive patterns 21 placed in parallel to one another on a flat surface formed from an insulating body so as to extend in a first direction, and also has a resistive element 10 that spans the two conductive patterns 21 and is electrically connected to the conductive patterns 21 at superimposing parts 10b superimposed on the conductive patterns 21, the resistance adjustment circuit 1 being configured to adjust a combined resistance generated across a predetermined position P1 on one conductive pattern 21 and a predetermined position P2 on the other conductive pattern 21. A plurality of resistive elements 10 are provided so as to be spaced in the first direction and are connected in parallel to one another across the two conductive patterns 21. The resistance adjustment method has a trimming process step of cutting part of the conductive patterns 21 between the superimposing parts 10b of resistive elements 10 disposed adjacently.

In this structure, a plurality of resistive elements 10 connected as a single parallel circuit can be reformed as a combination of a plurality of parallel circuits or a combination of parallel circuits and series circuits by cutting part of the conductive patterns 21. This enables the combined resistance to be adjusted.

In the trimming process step, part of the conductive patterns 21 is preferably cut by using a laser. In this structure, since a laser is used to cut part of the conductive patterns 21, a conductive pattern 21 can be easily removed.

### Second Embodiment

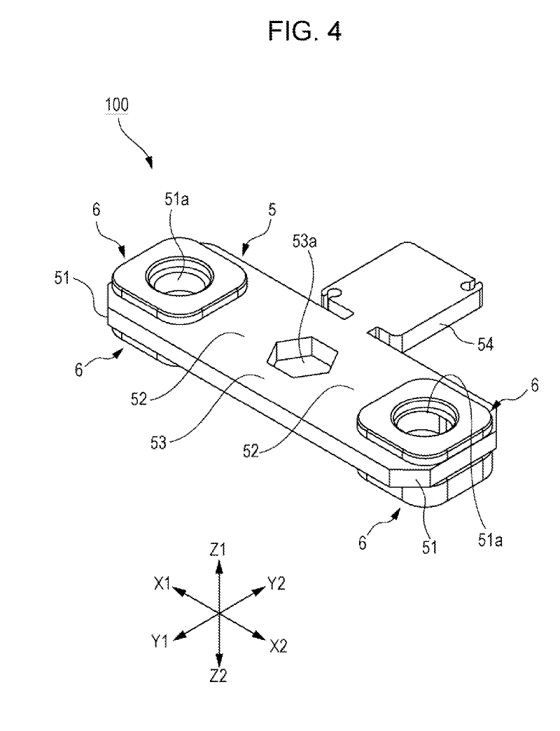

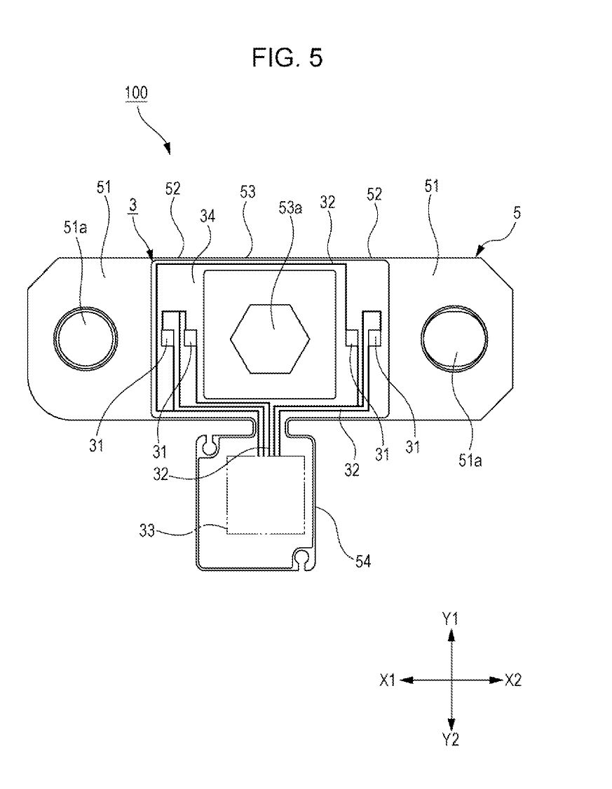

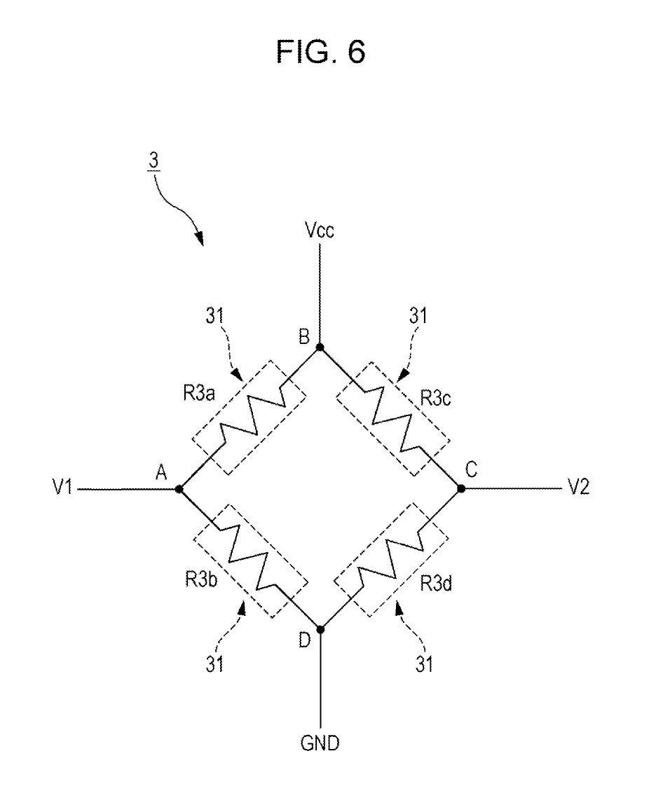

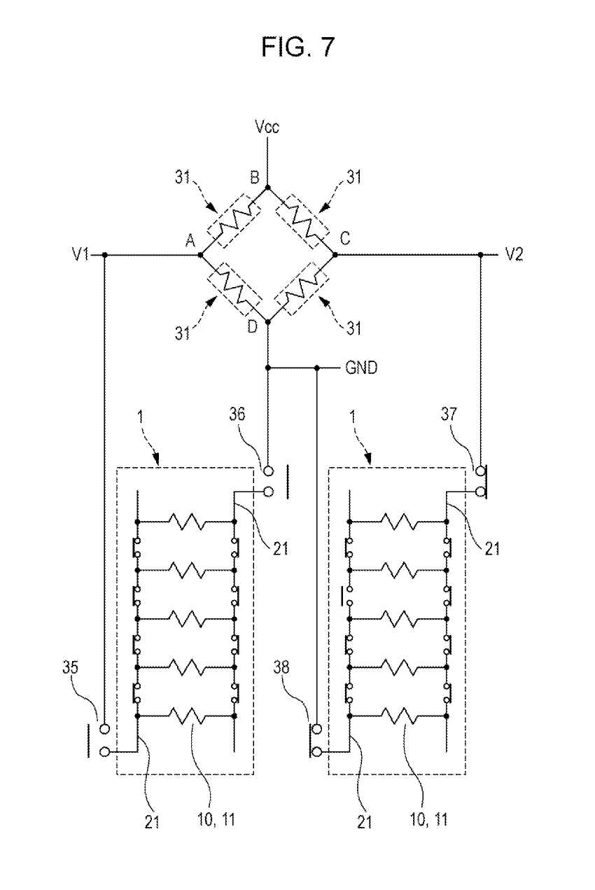

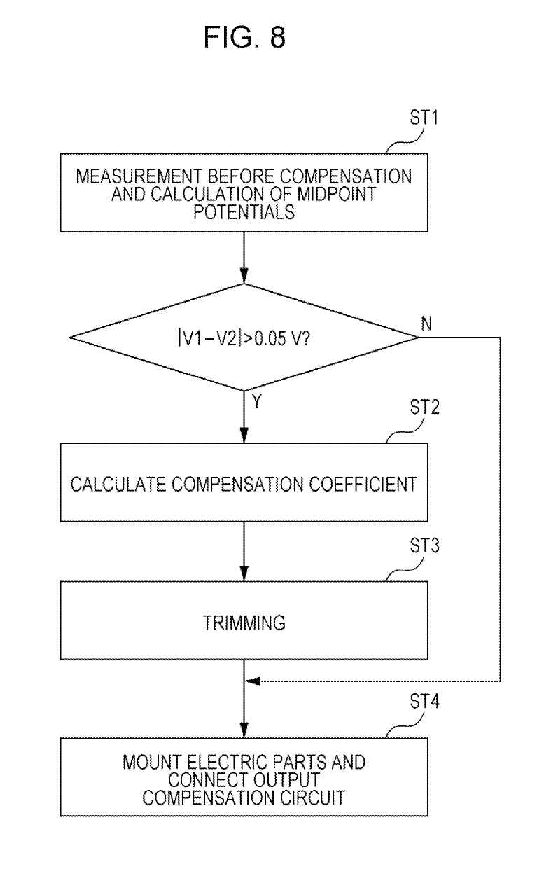

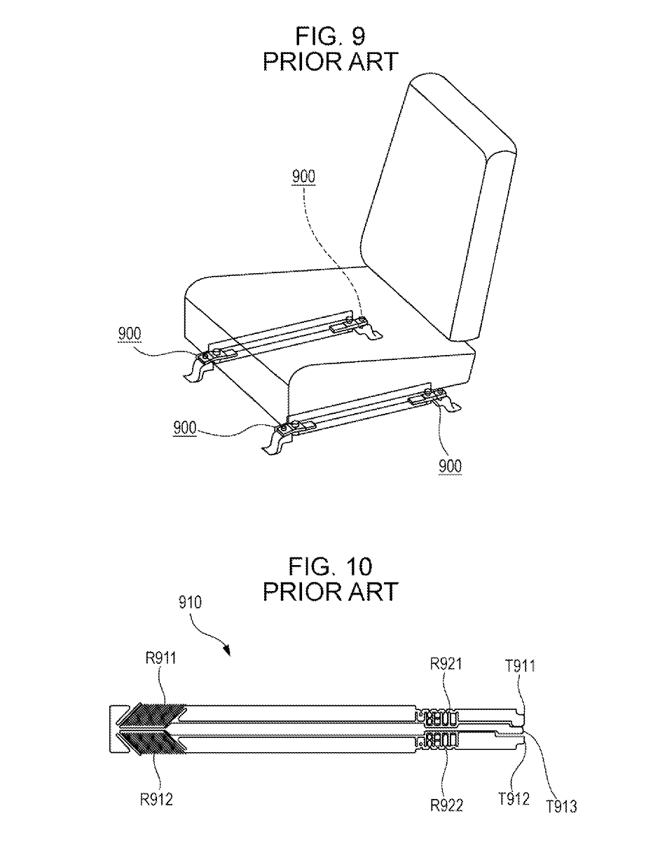

FIG. 4 is a perspective view illustrating a load detector 100 in a second embodiment. FIG. 5 is a bottom view illustrating the load detector 100 in the second embodiment. FIG. 6 is a circuit diagram illustrating a detecting part 3. FIG. 7 is an equivalent circuit diagram illustrating an example of electric connections between the detecting part 3 and the resistance adjustment circuit 1. FIG. 8 is a flowchart illustrating resistance adjustment method in the second embodiment. The same elements as in the resistance adjustment circuit 1 in the first embodiment are assigned the same reference numerals.

Load Detector

As illustrated in FIGS. 4 and 5, the load detector 100 has a base material 5 in a plate shape that includes an attachment part 51, a deformation part 52, a receiving part 53, and an output compensation part 54, and also includes a detection part 3 that outputs an electric signal in response to the deformation of the deformation part 52 of the base material 5. The load detector 100 detects the value of a load applied to the receiving part 53.

The base material 5 is made of a stainless steel plate. An attachment through-hole 51a is formed in the attachment part 51 of the base material 5. A reception part through-hole 53a is formed in the receiving part 53. A ring-shaped attachment member 6 for use for reinforcement is formed around the attachment through-hole 51a, the ring-shaped attachment member 6 being integrated with the base material 5 by being welded. The load detector 100 is attached so that a load is applied to the receiving part 53 through a receiving member (not illustrated) attached to the reception part through-hole 53a in a state in which the attachment part 51 is held by a member inserted into the attachment through-hole 51a through the ring-shaped attachment member 6. This load deforms the deformation part 52, warping it in the Z1-Z2 direction.

As illustrated in FIG. 5, the detection part 3 is disposed on the bottom surface (surface on the Z2 side) of the base material 5. The detection part 3 has four detection elements 31 and also preferably has wires 32 electrically connected to the four detection elements 31. The detection elements 31 and wires 32 are preferably placed on an insulating film 34 having a flat surface formed from an insulating body. Although the detection elements 31 and wires 32 are covered with a solder resist after they have been disposed, the solder resist is not illustrated in FIG. 5.

In the detection part 3, the detection elements 31 are preferably disposed on the bottom surface of the deformation part 52 so that the deformation of the deformation part 52 of the base material 5 can be detected. Each detection element 31 is preferably formed from a resistive film including a resistive material. When the detection element 31 receives a compressive stress, its resistance is reduced. When the detection element 31 receives a tensile stress, its resistance is increased. Due to this property, the detection element 31 detects a strain. An example of the resistive material is a ruthenium oxide (RuO₂) material. By screen-printing a raw material in paste form or printing it in another method and then sintering the raw material, the detection element 31 can be formed as a resistive film in which the resistive material is mixed with an inorganic binder. The resistive film can be formed easier by printing and sintering than when the resistive film is formed by, for example, bonding metal foil plates together.

The detection part 3 is a resistive circuit formed by connecting four detection elements 31 as a bridge circuit as illustrated in FIG. 6. The detection part 3 takes, as an output voltage, a difference between midpoint potentials V1 and V2 at two positions (A and C) relative to a voltage applied across positions B and D. The detection part 3 is placed so that resistors R3a and R3b respectively receive a compressive stress and a tensile stress and resistors R3c and R3d respectively receive a compressive stress and a tensile stress, in response to the deformation of the deformation part 52 of the base material 5. In this case, the resistors R3a and R3d receive a compressive stress at the same time, and the resistors R3b and R3c receive a tensile stress at the same time. The above relationship between a compressive stress and a tensile stress may be reversed.

The wires 32 are electrically connected to the connection parts of the four detection elements 31, and preferably extend from positions A, B, C, and D in FIG. 6 to an output compensation circuit 33 as illustrated in FIG. 5. The output compensation circuit 33 is preferably placed in the output compensation part 54, which is disposed at a position different from a position at which the deformation part 52 of the base material 5 is disposed. The output compensation circuit 33 is placed on the insulating film 34 having a flat surface formed from an insulating body.

The output compensation circuit 33 applies a predetermined voltage (5 V, for example) across positions B and D in FIG. 6, amplifies a difference between potentials at positions A and C in FIG. 6, and outputs the amplified difference. At that time, the resistances of the resistors R3a, R3b, R3c, and R3d in the detection element 31 are preferably the same in a predetermined state (in an initial state in which there is no load, for example) so that a difference between potentials at positions A and C becomes 0 V±0.05 V. In the load detector 100 in this embodiment, the output compensation circuit 33 has the resistance adjustment circuit 1 in the first embodiment and can be electrically connected so that the resistance adjustment circuit 1 compensates the midpoint potential at least one position. The resistance adjustment circuit 1 has been described in detail in the first embodiment.

The detection part 3 and resistance adjustment circuit 1 can be electrically connected as illustrated in, for example, FIG. 7. In FIG. 7, one resistance adjustment circuit 1 is disposed between positions A and D so as to be connectable in parallel, and another resistance adjustment circuit 1 is disposed between positions C and D so as to be connectable in parallel. By keeping switches 37 and 38 turned on, the midpoint potential V2 is made to be lower than before the connection. Although the switches 37 and 38 in the equivalent circuit may be mechanical switches, they may be semiconductor switches or dummy chips. Alternatively, jumper wires may be soldered to make electrical connections. To lower the midpoint potential V1, switches 35 and 36 are kept turned on.

In the resistance adjustment circuit 1, when part of the conductive patterns 21 is selectively cut to reduce the number of parallel connections of resistive elements 10 or combine parallel connections of resistive elements 10 with their series connections, the combined resistance of the resistance adjustment circuit 1 can be adjusted. In the example in FIG. 7, part of the conductive patterns 21 is cut so that the equivalent circuit in FIG. 3C is obtained. When the resistance adjustment circuit 1 is connected in parallel between positions A and D or between positions C and D, a difference between the midpoint potentials V1 and V2 can be compensated by using the combined resistance of the resistance adjustment circuit 1.

In the load detector 100 in this embodiment, the detection part 3 and output compensation circuit 33 are placed on the insulating film 34, which has a flat surface formed from an insulating body. Each detection element 31 in the detection part 3 and each resistive element 10 in the resistance adjustment circuit 1 disposed in the output compensation circuit 33 are formed from resistive films including the same resistive material. All resistive elements 10 are preferably disposed so that they have the same resistance. By screen-printing a raw material in paste form or printing it in another method and then sintering the raw material, the detection elements 31 and resistive elements 10 can be formed at the same time as resistive films in which the resistive material is mixed with an inorganic binder. Thus, the detection elements 31 and resistive elements 10 can be formed simultaneously in one manufacturing process, shortening the process to manufacture the load detector 100.

Each conductive pattern 21 in the resistance adjustment circuit 1 and each wire 32 in the detection part 3 are formed from the same conductive film including silver. By screen-printing a raw material in paste form or printing it in another method and then sintering the raw material, the conductive patterns 21 and wires 32 can be formed at the same time. Thus, the conductive patterns 21 and wires 32 can be formed simultaneously in one manufacturing process, shortening the process to manufacture the load detector 100.

Resistance Adjustment Method

The method of adjusting the resistance of the load detector 100 is performed by following the procedure illustrated in FIG. 8.

In a pre-compensation measurement step ST1, the resistance of each detection element 31 is measured in a state in which the wires 32 extending to the output compensation circuit 33 are open, after which the midpoint potentials V1 and V2 at two positions are calculated from the measured resistances. Although, in this embodiment, the midpoint potentials V1 and V2 are theoretically calculated from the measured resistances, this is not a limitation; a predetermined voltage (5 V, for example) may be applied across positions B and D in FIG. 6 and the midpoint potentials V1 and V2 at positions A and C in FIG. 6 may be actually measured.

Next, according to a difference between the two midpoint potentials V1 and V2, which have been calculated in the pre-compensation measurement step ST1, it is decided whether the differential voltage needs to be compensated. If, for example, the difference between the potentials at positions A and C is not within the range of 0 V±0.05 V, it is decided that the differential voltage needs to be compensated, so the processing proceeds to a compensation coefficient calculation step ST2.

In the compensation coefficient calculation step ST2, in view of the measured resistances of the detection elements 31, an adjusted resistance is calculated that is needed when any one of the two resistance adjustment circuits 1 illustrated in FIG. 7 is electrically connected.

In a trimming process step ST3, the combined resistance of the resistance adjustment circuit 1 to be used is adjusted to the adjusted resistance calculated in the compensation coefficient calculation step ST2. In the trimming process step ST3, the combined resistance is adjusted by preferably cutting part of the conductive patterns 21 in the resistance adjustment circuit 1 by using a laser. The resistance adjustment circuit 1 can be reformed as a combination of a plurality of parallel circuits, a combination of parallel circuits and series circuits, or a single series circuit by changing positions at which conductive patterns 21 are cut or changing the number of these positions. Since optimum trimming is performed according to the calculated adjusted resistance, the resistances of the resistive elements 10 in the resistance adjustment circuit 1 are preferably measured in advance in the pre-compensation measurement step ST1.

In the load detector 100, all resistive elements 10 in the resistance adjustment circuit 1 are preferably disposed so that they have the same resistance. Therefore, a calculation to have the combined resistance match the calculated adjusted resistance is easy. Since the resistance adjustment circuit 1 can be reformed as a combination of a plurality of parallel circuits, a combination of parallel circuits and series circuits, or a single series circuit by changing positions at which conductive patterns 21 are cut or changing the number of these positions, a difference between the midpoint potentials V1 and V2 can be precisely adjusted.

Since, in the trimming process step ST3, the differential voltage is compensated by cutting part of the conductive patterns 21 in the resistance adjustment circuit 1, it is not necessary to perform trimming in which the resistive films of the detection elements 31 and resistive elements 10 are partially cut. Unlike this embodiment, trimming in which resistive films are partially cut has been problematic in that a crack is generated from a portion at which the resistive film was cut or the property of the resistive film at the cut surface is changed and the adjusted resistance is thereby changed. In this embodiment, this problem does not occur; after the trimming process step ST3, the resistances of the resistive elements 10 themselves do not change with time. Therefore, the combined resistance of the resistance adjustment circuit 1 after the adjustment is stably maintained at a desired value.

In a compensation circuit connection step ST4, a conditioning integrated circuit (IC), a chip resistor, a chip capacitor, and other electric parts (these parts are not illustrated) are mounted in the output compensation circuit 33, and the output compensation circuit 33 including the resistance adjustment circuit 1 to be used is electrically connected to the detection part 3. Since the resistive element 10 in the resistance adjustment circuit 1 has the same temperature coefficient as the detection element 31, temperature compensation set by the conditioning IC is easy.

Effects in this embodiment will be described below.

The load detector 100 in this embodiment has a base material 5 having a deformation part 52, a detection part 3 that outputs an electric signal in response to the deformation of the base material 5, and a resistance adjustment circuit 1 disposed so as to be electrically connected to the detection part 3; the detection part 3 is a resistance circuit having a bridge circuit formed by connecting four detection elements 31, the resistance circuit taking, as an output voltage, a difference between midpoint potentials V1 and V2 at two positions relative to an applied voltage; the resistance adjustment circuit 1 is electrically connectable so as to compensate a midpoint potential at at least one position; the resistance adjustment circuit 1 is placed on a flat surface at a position different from a position at which the deformation part 52 is disposed, the flat surface being formed from an insulating body and disposed on the base material 5; the resistance adjustment circuit 1 has a plurality of conductive patterns 21 placed in parallel to one another so as to extend in a first direction, and also has a resistive element 10 that spans two conductive patterns 21 and is electrically connected to the conductive patterns 21 at superimposing parts 10b superimposed on the conductive patterns 21; the resistive element 10 is spaced in the first direction and are connected in parallel to one another across the two conductive patterns 21; part of the conductive patterns 21 can be selectively cut between the superimposing parts 10b of resistive elements 10 disposed adjacently.

In this structure, part of the conductive patterns 21 is selectively cut to reduce the number of parallel connections of resistive elements 10 in the resistance adjustment circuit 1 or combine parallel connections of resistive elements 10 with their series connections, so it is possible to provide the load detector 100 with which a difference between midpoint potentials V1 and V2 in the detection part 3 can be easily compensated.

Each conductive pattern 21 is formed from a conductive film including silver, and each resistive element 10 is a resistive pattern 11 formed from a resistive film including a resistive material. In this structure, both the conductive pattern 21 formed from a conductive film including silver and the resistive pattern 11 formed from a resistive film including a resistive material can be formed by, for example, screen printing, so their formation is easier than when they are formed by, for example, bonding metal foil plates together.

All resistive elements 10 are placed so as to have the same resistance. In this structure, when the number of parallel connections of resistive elements 10 is reduced or parallel connections of resistive elements 10 are combined with their series connections, a resistance can be easily calculated.

The detection part 3 has wires 32 electrically connected to the connection parts of four detection elements 31. Each detection element 31 is formed from a resistive film. The detection elements 31 and wires 32 are placed on a flat surface formed from an insulating body. The detection elements 31 are disposed in the deformation part 52 mounted on the base material 5. The wires 32 extend from the deformation part 52 on the base material 5 to the output compensation part 54 disposed at a position different from a position at which the deformation part 52 is disposed. The resistance adjustment circuit 1 is disposed in the output compensation part 54 on the base material 5, and the conductive patterns 21 are electrically connectable to the wires 32. In this structure, since each detection element 31 and each resistive element 10 in the resistance adjustment circuit 1 are formed from the same resistive film, they have the same temperature coefficient, so the temperature of the load detector 100 is easily compensated. In addition, the detection elements 31 and resistive elements 10 can be formed simultaneously in one manufacturing process.

Each conductive pattern 21 and each wire 32 are formed from the same conductive film. In this structure, the conductive patterns 21 and wires 32 can be formed simultaneously in one manufacturing process.

The resistance adjustment method in this embodiment adjusts the resistance of a load detector 100 that has a base material 5 having a deformation part 52, a detection part 3 that outputs an electric signal in response to the deformation of the base material 5, and a resistance adjustment circuit 1 disposed so as to be electrically connected to the detection part 3; the detection part 3 is a resistance circuit having a bridge circuit formed by connecting four detection elements 31, the resistance circuit taking, as an output voltage, a difference between midpoint potentials V1 and V2 at two positions relative to an applied voltage. The resistance adjustment circuit 1 is electrically connectable so as to compensate a midpoint potential at at least one position; the resistance adjustment circuit 1 is placed on a flat surface at a position different from a position at which the deformation part 52 is disposed, the flat surface being formed from an insulating body and disposed on the base material 5; the resistance adjustment circuit 1 has a plurality of conductive patterns 21 placed in parallel to one another so as to extend in a first direction, and also has a resistive element 10 that spans two conductive patterns 21 and is electrically connected to the conductive patterns 21 at superimposing parts 10b superimposed on the conductive patterns 21; the resistive element 10 is spaced in the first direction and are connected in parallel to one another across the two conductive patterns 21. The resistance adjustment method includes a pre-compensation measurement step ST1 of measuring the midpoint potentials V1 and V2 at two positions, a compensation coefficient calculation step ST2 of calculating a necessary adjusted resistance from a difference between the midpoint potentials V1 and V2 measured in the pre-compensation measurement step ST1 at two positions, a trimming process step ST3 of cutting part of the conductive patterns 21 between the superimposing parts 10b of resistive elements 10 disposed adjacently to adjust the combined resistance of the resistance adjustment circuit 1 to the adjusted resistance calculated in the compensation coefficient calculation step ST2, and a compensation circuit connection step ST4 of electrically connecting the resistance adjustment circuit 1 to the detection part 3.

In this structure, since the resistance adjustment circuit 1 can be reformed as a combination of a plurality of parallel circuits, a combination of parallel circuits and series circuits, or a single series circuit by changing positions at which conductive patterns 21 are cut or changing the number of these positions, a difference between the midpoint potentials V1 and V2 can be precisely adjusted.

In the trimming process step ST3, part of the conductive patterns 21 is cut by using a laser. In this structure, since a laser is used to cut part of the conductive patterns 21, a conductive pattern 21 can be easily removed.

So far, the resistance adjustment circuit 1 in the first embodiment of the present invention and the load detector 100 and resistance adjustment method in the second embodiment have been specifically described, but the present invention is not limited to the above embodiments. Various changes are possible without departing from the intended scope of the present invention. For example, the present invention can also be practiced by making variations as described below. These variations are also included in the technical range of the present invention.

(1) Although, in the first and second embodiments, two conductive patterns 21 have been placed side by side in the resistance adjustment circuit 1, its structure may be changed so that three or more conductive patterns 21 are placed side by side. The combined resistance of the resistance adjustment circuit 1 can be more precisely adjusted by increasing the number of conductive patterns 21 or more increasing the number of resistive elements 10 to be provided.

(2) Although, in the second embodiment, the resistance adjustment circuit 1 has been electrically connected to the detection part 3 in the compensation circuit connection step ST4, the resistance adjustment circuit 1 may be electrically connected to the detection part 3 in advance. In this structure, it suffices to cut an unnecessary part of the conductive patterns 21 after the combined resistance of the resistance adjustment circuit 1 yet to be trimmed has been measured.

(3) Although, in the second embodiment, the resistive element 10 in the resistance adjustment circuit 1 has been formed from the same resistive film as in the detection element 31, the resistive element 10 may be formed from a resistive film made of a different material. The resistive element 10 is not limited to the resistive pattern 11; the resistive element 10 may be formed from a chip resistor. Since part of the conductive patterns 21 is trimmed rather than the resistive elements 10, it is possible to use a chip resistor as the resistive element 10.

(4) Although, in the second embodiment, two resistance adjustment circuits 1 have been disposed, this structure may be changed so that four resistance adjustment circuits 1 are disposed in correspondence to the four detection elements 31. Since it suffices to use one resistance adjustment circuit 1, one detection element 31 to be connected may be determined in advance. Then, its resistance may be changed, after which the resistance adjustment circuit 1 may be disposed in correspondence to that detection element 31 and the resistance may be adjusted without fail. Although a circuit structure has been described in which resistance adjustment circuits 1 are connected in parallel to detection elements 31, resistance adjustment circuits 1 may be connected in series with a half bridge formed from two detection elements 31.

What is claimed is:

1. A resistance adjustment circuit comprising:
a plurality of conductive patterns placed in parallel to one another on a flat surface comprising an insulating body so as to extend in a first direction;
a resistive element that spans two conductive patterns and is electrically connected to the conductive patterns at superimposing parts superimposed on the conductive patterns; wherein
a plurality of resistive elements provided so as to be spaced in the first direction and connected in parallel to one another across the two conductive patterns, and
part of the conductive patterns being capable of being selectively cut between the superimposing parts of resistive elements disposed adjacently.

2. The resistance adjustment circuit according to claim 1, wherein:
each of the plurality of conductive patterns is comprised of a conductive film including silver; and
the resistive element comprises a resistive pattern of a resistive film including a resistive material.

3. The resistance adjustment circuit according to claim 1, wherein all of the plurality of resistive elements are placed so as to have the same resistance.

4. A load detector comprising;
a base material having a deformation part;
a detection part that outputs an electric signal in response to a deformation of the base material; and
a resistance adjustment circuit disposed so as to be electrically connected to the detection part; wherein:
the detection part is a resistance circuit having a bridge circuit formed by connecting four detection elements, the resistance circuit taking, as an output voltage, a difference between midpoint potentials at two positions relative to an applied voltage,
the resistance adjustment circuit is electrically connectable so as to compensate a midpoint potential at at least one position,
the resistance adjustment circuit is placed on a flat surface at a position different from a position at which the deformation part is disposed, the flat surface comprising an insulating body and disposed on the base material,
the resistance adjustment circuit includes:
a plurality of conductive patterns placed in parallel to one another so as to extend in a first direction, and
a resistive element that spans two conductive patterns and is electrically connected to the conductive patterns at superimposing parts superimposed on the conductive patterns,
a plurality of resistive elements provided so as to be spaced in the first direction and connected in parallel to one another across the two conductive patterns, and
part of the conductive patterns being capable of being selectively cut between the superimposing parts of resistive elements disposed adjacently.

5. The load detector according to claim 4, wherein:
each of the plurality of conductive patterns is comprises of a conductive film including silver; and
the resistive element comprises a resistive pattern formed from a resistive film including a resistive material.

6. The load detector according to claim 5, wherein all of the plurality of resistive elements are placed so as to have the same resistance.

7. The load detector according to claim 5, wherein:
the detection part has wires electrically connected to connection parts of the four detection elements; wherein:
each of the four detection elements is comprised of a resistive film, the detection elements and wires being placed on a flat surface formed from an insulating body;
the detection elements are disposed in the deformation part mounted on the base material, and the wires extend from the deformation part on the base material to the output compensation part disposed at a position different from a position at which the deformation part is disposed;
the resistance adjustment circuit is disposed in the output compensation part on the base material; and
the conductive patterns are electrically connectable to the wires.

8. The load detector according to claim 7, wherein each of the conductive patterns and each of the wires are comprised of the same conductive film.

9. A resistance adjustment method applied to a resistance adjustment circuit that includes:
two conductive patterns placed in parallel to each other on a flat surface comprised of an insulating body so as to extend in a first direction, and
a resistive element that spans the two conductive patterns and is electrically connected to the conductive patterns at superimposing parts superimposed on the conductive patterns, wherein:
the resistance adjustment circuit adjusts a combined resistance generated across a predetermined position on one conductive pattern and a predetermined position on another conductive pattern,
a plurality of resistive elements are provided so as to be spaced in the first direction and are connected in parallel to one another across the two conductive patterns, and
a trimming process step of cutting part of the conductive patterns between the superimposing parts of resistive elements disposed adjacently.

10. A resistance adjustment method of adjusting a resistance of a load detector that includes:
a base material having a deformation part,
a detection part that outputs an electric signal in response to a deformation of the base material, and
a resistance adjustment circuit disposed so as to be electrically connected to the detection part, wherein
the detection part is a resistance circuit having a bridge circuit formed by connecting four detection elements, the resistance circuit taking, as an output voltage, a difference between midpoint potentials at two positions relative to an applied voltage,
the resistance adjustment circuit is electrically connectable so as to compensate a midpoint potential at at least one position, is placed on a flat surface at a position different from a position at which the deformation part is disposed, the flat surface being formed from an insulating body and disposed on the base material, and has a plurality of conductive patterns placed in parallel to one another so as to extend in a first direction and a resistive element that spans two conductive patterns and is electrically connected to the conductive patterns at superimposing parts superimposed on the conductive patterns,
a plurality of resistive elements are provided so as to be spaced in the first direction and are connected in parallel to one another across the two conductive patterns, and
the resistance adjustment method includes:
a pre-compensation measurement step of measuring the midpoint potentials at two positions,
a compensation coefficient calculation step of calculating a necessary adjusted resistance from a difference between the midpoint potentials measured in the pre-compensation measurement step at two positions,
a trimming process step of cutting part of the conductive patterns between the superimposing parts of resistive elements disposed adjacently to adjust a combined resistance of the resistance adjustment circuit to the adjusted resistance calculated in the compensation coefficient calculation step, and
a compensation circuit connection step of electrically connecting the resistance adjustment circuit to the detection part.

11. The resistance adjustment method according to claim 9, wherein in the trimming process step, part of the conductive patterns is cut using a laser.
